(19) United States
(12) Patent Application Publication
(10) Pub. No.: US 2018/0336651 A1
(43) Pub. Date: Nov. 22, 2018

(54) Transparency Mobile Legal Assistance (TMLA)

(71) Applicant: Malik Azim, Oakland, CA (US)

(72) Inventor: Malik Azim, Oakland, CA (US)

(21) Appl. No.: 15/598,154

(22) Filed: May 17, 2017

(51) Int. Cl. G06Q 50/18; H04M 1/725; H04W 4/00; G06Q 20/28; H04N 7/14; H04N 5/91

(52) U.S. Cl. CPC G06Q 50/18; H04M 1/72555; H04W 4/003; H04N 5/91; H04M 1/72525; H04N 7/141; G06Q 20/28

(57) ABSTRACT

A service and method by means of an application creating transparency involving a legal third-party when being pulled over by authorities via a handheld portable or mountable device providing visual and audio legal assistance and the ability to create compliance and witnesses.

### BACKGROUND OF THE INVENTION

### Problem Solved

The application will be a mechanism to assist with the current violence involving law-enforcement and citizens. From my understanding and research there's nothing like this out there.

### DETAILED DESCRIPTION OF THE INVENTION

The service being offered is a legal prepaid service by the means of an application that will immediately link a paid client to prepaid law firm up to 24/7 or per service level agreement with firm. This service is offered via an application that will be created to support the services. The method of delivery could be a mobile phone, both IOS and/or Android platforms or a mounted dash cam device linked to the app either via Bluetooth, cable or installed software. The application will give the client both audio and video, as well as the ability to text if needed. The application and services will address the current issue with relationships between law enforcement and citizens during routine stops, it will be a mechanism for monitoring proper behavior of both officers and citizens. It creates awareness and accountability for all involved and transparency. Currently, there is nothing capturing real-time relationships between the authority and citizens from a legal or citizen prospective. It gives everyone transparency and calmness with a benefit of legal witnesses.

Services that can be offered are not limited to just above, use of the application can and will be expanded to other legal services deem feasible by an attorney and client.

### The Version of The Invention Discussed Here Includes:

1. A smart device with camera, audio, application and data capability
2. An application that supports interactive communication both audio and video.
3. Services that includes levels of service agreements between citizens and selected legal entity.

### Relationship Between the Components:

Smart device with the ability to download applications, ability to live stream videos, supporting both audio and video. Service Level Agreements will determine the level of support and ability to provide said services.

### How the Invention Works:

Upon visual confirmation of request to pull over, the citizen either use a voice prompt to open the application or press the application to open it. You press the “Request Legal Counsel” button, you select your attorney and press the talk button, your call is placed on a speaker device setting. You are asked if you are being pulled over, you are directed to pull over in a safe manner and giving instructions on staying calm. Once the cop approaches your vehicle, you comply with his commands but be transparent in letting the officer know you have legal representation on a video call. The video and audio is recorded and uploaded to the attorney's site and can only be release in compliance with the legal mandates.

### How to Make the Invention:

The application is a programmed designed to act as a live video stream between the person who purchased the application and the law firm representing the prepaid client. The application will be coded and developed as an Android and IOS Application utilizing a cross-platform development tool. The legal entity will use an on-premise software or cloud based installation to support the application and storage of videos, in accordance to their security and privacy needs.

### How to Use the Invention:

The end product, i.e., the video conversation will be used as a service to ease burden of proof in contentious legal matter around the incident. It also gives a legal witness point of view.

Sample feel and look of the application.

[symbol]

[symbol]

Having described various embodiments of the invention, what is claimed as new and desired to be protected by Letters Patent includes the following claims:

1. An application and smart device for private citizens consisting of a smart device with camera and microphone configurable for visibility and two-way communication between citizen and a legal entity in a private citizen vehicle; a motion capable device housed within the smart device and configured to capture a video of an event; with the capability to record the captured video event; with a response activated mechanism mounted on or in the device and configured for motion detection.

2. The application and smart device of claim 1, wherein two-way communication will be between a smart device; loaded with the TMLA application or connectivity to the application via cloud services or direct Bluetooth or USB connectivity.

3. The application and smart device of claim 2, wherein smart device can be mobile device, dash cam but not limited to a stand-alone device with application being loaded.

4. The application and smart device of claim 1, wherein the application is activated upon an incident by the private citizen to initiate contact with legal entity; movements can be captured by motion detection or mounted device.

5. The application and smart device of claim 2, wherein the private citizen will purchase an application and service from an attorney for legal services; said legal services will activate the application for use of services.

6. The application and smart device of claim 1, wherein the captured motion at any time records a geographical location as one function of the system when a motion is detected or a call is made by private citizens.

7. The application and smart device of claim 2, wherein the processing element receives, from a global positioning system, information indicative of the geographical location of the at least one component of the system.

8. The application and smart device of claim 1, wherein said mounted device is mounted on a rearview mirror or inside the private citizen's vehicle.

9. The application and smart device of claim 4, further including; a second mounting of a smart device in a rear window to be used interchangeably.

10. The application and smart device of claim 1, wherein the mobile device is configured to transmit a video to the prepaid legal entity for capturing and storage.

11. The application and smart device of claim 6, wherein the storage device is configured for storage and viewing of the video file on any monitoring device.

12. The application and smart device of claim 8, wherein an attorney will offer a service level agreement.

13. The application and smart device of claim 1, wherein is configured to allow a direct call to pre-selected legal entity upon a traffic stop or any authoritative stop of a private citizen by an officer of the law.
